(19) United States
(12) Patent Application Publication
(10) Pub. No.: US 2018/0189966 A1
(43) Pub. Date: Jul. 5, 2018

(54) SYSTEM AND METHOD FOR GUIDANCE OF LAPAROSCOPIC SURGICAL PROCEDURES THROUGH ANATOMICAL MODEL AUGMENTATION

(71) Applicant: Siemens Aktiengesellschaft, Munich (DE)

(72) Inventors: Ali Kamen, Skillman, NJ (US); Stefan Kluckner, Berlin (DE); Yao-jen Chang, Princeton, NJ (US); Tommaso Mansi, Plainsboro, NJ (US); Tiziano Passerini, Plainsboro, NJ (US); Terrence Chen, Princeton, NJ (US); Peter Mountney, London (GB); Anton Schick, Velden (DE)

(21) Appl. No.: 15/570,469

(22) PCT Filed: May 7, 2015
(86) PCT No.: PCT/US2015/029680

§ 371 Date: Oct. 30, 2017

(51) Int. Cl. G06T 7/33; G06T 15/04

(52) U.S. Cl. CPC G06T 7/344; G06T 15/04; G06T 2210/41; G06T 2200/08; G06T 2207/30056; G06T 2200/04

(57) ABSTRACT

Systems and methods for model augmentation include receiving intra-operative imaging data of an anatomical object of interest at a deformed state. The intra-operative imaging data is stitched into an intra-operative model of the anatomical object of interest at the deformed state. The intra-operative model of the anatomical object of interest at the deformed state is registered with a pre-operative model of the anatomical object of interest at an initial state by deforming the pre-operative model of the anatomical object of interest at the initial state based on a biomechanical model. Texture information from the intra-operative model of the anatomical object of interest at the deformed state is mapped to the deformed pre-operative model to generate a deformed, texture-mapped pre-operative model of the anatomical object of interest.

### BACKGROUND OF THE INVENTION

The present invention relates generally to image-based guidance of laparoscopic surgical procedures and more particularly to targeting and localization of anatomical structures during laparoscopic surgical procedures through anatomical model augmentation.

Currently, during minimally invasive abdominal procedures, such as minimally invasive tumor resection, either stereoscopic or conventional video laparoscopy is used to help guide the clinician to the target tumor site while avoiding critical structures. Having access to preoperative imaging information during the procedure is extremely useful, as the tumor and critical structures are not directly visible from the laparoscopic images. Preoperative information aligned to the views of the surgeon through the laparoscopic video enhances the perception and the ability of the surgeon in better targeting the tumor and avoiding critical structures around the target.

Often times, surgical procedures require insufflation of the abdomen, causing an initial organ shift and tissue deformation which must be reconciled. This registration problem is further complicated during the procedure itself due to the continuous tissue deformation caused by respiration and possible tool-tissue interactions.

Conventional systems available for fusion of intra-operative optical images and preoperative images include multi-modal fiducial based systems, manual registration based systems, and three-dimensional surface registration based systems. Fiducial based techniques require a set of common fiducials with both pre- and intra-operative image acquisitions, which are inherently disruptive to the clinical workflow as the patient has to be imaged in an extra step with fiducials. Manual registration is time-consuming and potentially inaccurate, particularly if the orientation alignments have to be continuously adjusted based on one or multiple two-dimensional images during the entire length of the procedure. Additionally, such manual registration techniques are not able to account for tissue deformation at the point of registration or temporal tissue deformation throughout the procedures. Three-dimensional surface based registration using biomechanical properties may compromise accuracy and performance due to its limited view of the surface structure of the anatomy of interest and the computational complexity in doing the deformation compensation in real-time.

### BRIEF SUMMARY OF THE INVENTION

In accordance with an embodiment, systems and methods for model augmentation include receiving intra-operative imaging data of an anatomical object of interest at a deformed state. The intra-operative imaging data is stitched into an intra-operative model of the anatomical object of interest at the deformed state. The intra-operative model of the anatomical object of interest at the deformed state is registered with a pre-operative model of the anatomical object of interest at an initial state by deforming the pre-operative model of the anatomical object of interest at the initial state based on a biomechanical model. Texture information from the intra-operative model of the anatomical object of interest at the deformed state is mapped to the deformed pre-operative model to generate a deformed, texture-mapped pre-operative model of the anatomical object of interest.

These and other advantages of the invention will be apparent to those of ordinary skill in the art by reference to the following detailed description and the accompanying drawings.

### BRIEF DESCRIPTION OF THE DRAWINGS

FIG. 1 shows a high-level framework for guidance during laparoscopic surgical procedures through anatomical model augmentation, in accordance with one embodiment;

FIG. 2 shows a system for guidance during laparoscopic surgical procedures through anatomical model augmentation, in accordance with one embodiment;

FIG. 3 shows an overview for generating a three dimensional model of an anatomical object of interest from initial intra-operative imaging data, in accordance with one embodiment;

FIG. 4 shows a method for guidance during laparoscopic surgical procedures through anatomical model augmentation, in accordance with one embodiment; and

FIG. 5 shows a high-level block diagram of a computer for guidance during laparoscopic surgical procedures through anatomical model augmentation, in accordance with one embodiment.

### DETAILED DESCRIPTION

The present invention generally relates to anatomical model augmentation for guidance during laparoscopic surgical procedures. Embodiments of the present invention are described herein to give a visual understanding of methods for augmenting anatomical models. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, it is to be understood that embodiments of the present invention may be performed within a computer system using data stored within the computer system.

Further, it should be understood that while the embodiments discussed herein may be discussed with respect to medical procedures of a patient, the present principles are not so limited. Embodiments of the present invention may be employed for augmentation of a model for any subject.

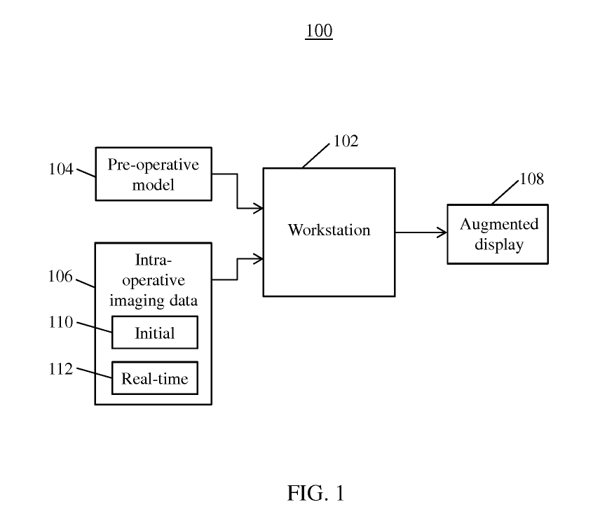

FIG. 1 shows a high-level framework 100 for guidance during laparoscopic surgical procedures, in accordance with one or more embodiments. During a surgical procedure performed, workstation 102 aids the user (e.g., surgeon) by providing image guidance and displaying other pertinent information. Workstation 102 receives pre-operative model 104 and intra-operative imaging data 106 of an anatomical object of interest of a patient, such as, e.g., the liver. Pre-operative model 104 is of the anatomical object of interest at an initial (e.g., relaxed or non-deformed) state while intra-operative imaging data 106 is of the anatomical object of interest at a deformed state. Intra-operative imaging data 106 includes initial intra-operative imaging data 110 and real-time intra-operative imaging data 112. Initial intra-operative imaging data 110 is acquired at an initial stage of the procedure to provide a complete scanning of the anatomical object of interest. Real-time intra-operative imaging data 112 is acquired during the procedure.

Pre-operative model 104 may be generated from pre-operative imaging data (not shown) of the liver, which may be of any modality, such as, e.g., computer tomography (CT), magnetic resonance imaging (MRI), etc. For example, the pre-operative imaging data may be segmented using any segmentation algorithm and converted to pre-operative model 104 using computational geometry algorithms library (CGAL). Other known methods may also be employed. Pre-operative model 104 may be, e.g., a surface or tetrahedral mesh of the liver. Pre-operative model 104 includes not only the surface of the liver, but also sub-surface targets and critical structures.

Intra-operative imaging data 106 of the liver may be received from an image acquisition device of any modality. In one embodiment, intra-operative imaging data 106 includes optical two-dimensional (2D) and three-dimensional (3D) depth maps acquired from a stereoscopic laparoscopic imaging device. Intra-operative imaging data 106 includes images, video, or any other imaging data of the liver at the deformed state. The deformation may be due to insufflation of the abdomen, or any other factor, such as, e.g., a natural internal motion of the patient (e.g., breathing), displacement from the imaging or surgical device, etc.

Workstation 102 generates a textured model of the liver aligned to the current (i.e., deformed) state of the patient from pre-operative model 104 and initial intra-operative imaging data 110. Specifically, workstation 102 applies a stitching algorithm to align frames of initial intra-operative imaging data 110 into a single intra-operative 3D model (e.g., surface mesh) of the anatomical object of interest at the deformed state. The intra-operative model is rigidly registered to pre-operative model 104. Pre-operative model 104 is locally deformed based on intrinsic biomechanical properties of the liver such that the deformed pre-operative model matches the stitched intra-operative model. The texture information from the stitched intra-operative model is mapped to the deformed pre-operative model to generate a deformed, texture-mapped pre-operative model.

A non-rigid registration is performed between the deformed, texture-mapped pre-operative model and real-time intra-operative imaging data 112 acquired during the procedure. Workstation 102 outputs augmented display 108 displaying the deformed, texture-mapped pre-operative model intra-operatively with real-time intra-operative imaging data 112. For example, the deformed, texture-mapped pre-operative model may be displayed with real-time intra-operative imaging data 112 in an overlaid or side-by-side configuration to provide a clinician with a better understanding of sub-surface targets and critical structures for efficient navigation and delivery of a treatment.

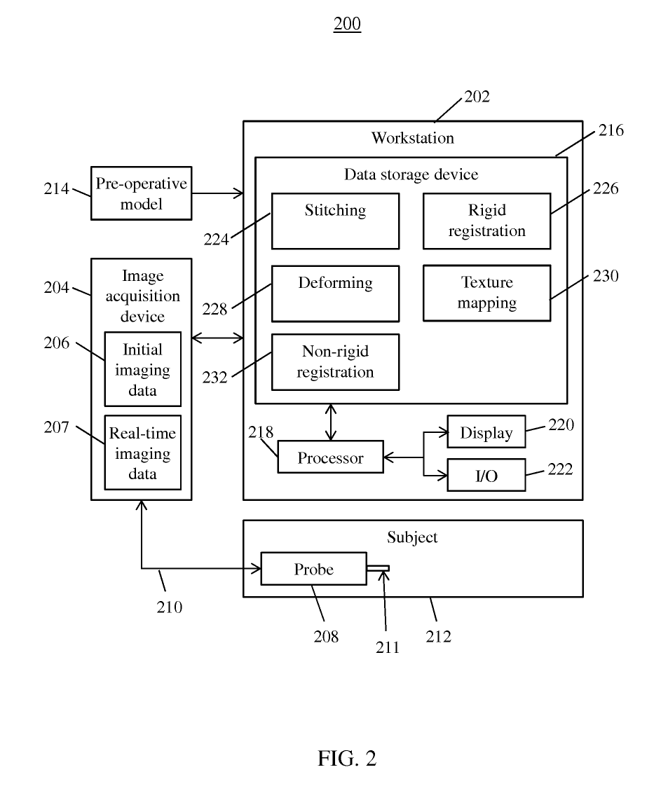

FIG. 2 shows a detailed view of system 200 for guidance during a laparoscopic surgical procedure through anatomical model augmentation, in accordance with one or more embodiments. Elements of system 200 may be co-located (e.g., within an operating room environment or facility) or remotely located (e.g., at different areas of a facility or different facilities). System 200 comprises workstation 202, which may be used for surgical procedures (or any other type of procedure). Workstation 202 may include one or more processors 218 communicatively coupled to one or more data storage devices 216, one or more displays 220, and one or more input/output devices 222. Data storage device 216 stores a plurality of modules representing functionality of workstation 202 performed when executed on processor 218. It should be understood that workstation 202 may include additional elements, such as, e.g., a communications interface.

Workstation 202 receives imaging data from image acquisition device 204 of object of interest 211 of subject 212 (e.g., a patient) intra-operatively during the surgical procedure. Imaging data may include images (e.g., frames), videos, or any other type of imaging data. Intra-operative imaging data from image acquisition device 204 may include initial intra-operative imaging data 206 and real-time intra-operative imaging data 207. Initial intra-operative imaging data 206 may be acquired at an initial stage of the surgical procedure to provide a complete scanning of object of interest 211. Real-time intra-operative imaging data 207 may be acquired during the procedure.

Intra-operative imaging data 206, 207 may be acquired while object of interest 211 is at a deformed state. The deformation may be due to insufflation of object of interest 211 or any other factor, such as, e.g., natural movements of the patient (e.g., breathing), displacement caused by imaging or surgical devices, etc. In one embodiment, intra-operative imaging data 206, 207 is intra-operatively received by workstation 202 directly from image acquisition device 204 imaging subject 212. In another embodiment, imaging data 206, 207 is received by loading previously stored imaging data of subject 212 acquired using image acquisition device 204.

In some embodiments, image acquisition device 204 may employ one or more probes 208 for imaging object of interest 211 of subject 212. Object of interest 211 may be a target anatomical object of interest, such as, e.g., an organ (e.g., the liver). Probes 208 may include one or more imaging devices (e.g., cameras, projectors), as well as other surgical equipment or devices, such as, e.g., insufflation devices, incision devices, or any other device. For example, insufflation devices may include a surgical balloon, a conduit for blowing air (e.g., an inert, nontoxic gas such as carbon dioxide), etc. Image acquisition device 204 is communicatively coupled to probe 208 via connection 210, which may include an electrical connection, an optical connection, a connection for insufflation (e.g., conduit), or any other suitable connection.

In one embodiment, image acquisition device 204 is a stereoscopic laparoscopic imaging device capable of producing real-time two-dimensional (2D) and three-dimensional (3D) depth maps of anatomical object of interest 211. For example, stereoscopic laparoscopic imaging device may employ two cameras, one camera with a projector, or two cameras with a projector for producing real-time 2D and 3D depth maps. Other configurations of the stereoscopic laparoscopic imaging device are also possible. It should be appreciated that imaging acquisition device 204 is not limited to a stereoscopic laparoscopic imaging device but may be of any modality, such as, e.g., ultrasound (US).

Workstation 202 may also receive pre-operative model 214 of anatomical object of interest 211 of subject 212. Pre-operative model 214 may be generated from pre-operative imaging data (not shown) acquired of the anatomical object of interest 211 at an initial (e.g., relaxed or non-deformed) state. Pre-operative imaging data may be of any modality, such as, e.g., CT, MRI, etc. Pre-operative imaging data provides for a more detailed view of anatomical object of interest 211 compared to intra-operative imaging data 206.

Surface targets (e.g., liver), critical structures (e.g., portal vein, hepatic system, biliary tract, and other targets (e.g., primary and metastatic tumors) may be segmented from the pre-operative imaging data using any segmentation algorithm. For example, the segmentation algorithm may be a machine learning based segmentation algorithm. In one embodiment, a marginal space learning (MSL) based framework may be employed, e.g., using the method described in U.S. Pat. No. 7,916,919, entitled “System and Method for Segmenting Chambers of a Heart in a Three Dimensional Image,” which is incorporated herein by reference in its entirety. In another embodiment, a semi-automatic segmentation technique, such as, e.g., graph cuts or random walker segmentation can be used. The segmentations may be represented as binary volumes. Pre-operative model 214 is generated by converting the binary volumes using, e.g., CGAL, VTK (visualization toolkit), or any other known tools. In one embodiment, pre-operative model 214 is a surface or tetrahedral mesh. In some embodiments, workstation 202 directly receives pre-operative imaging data and generates pre-operative model 214.

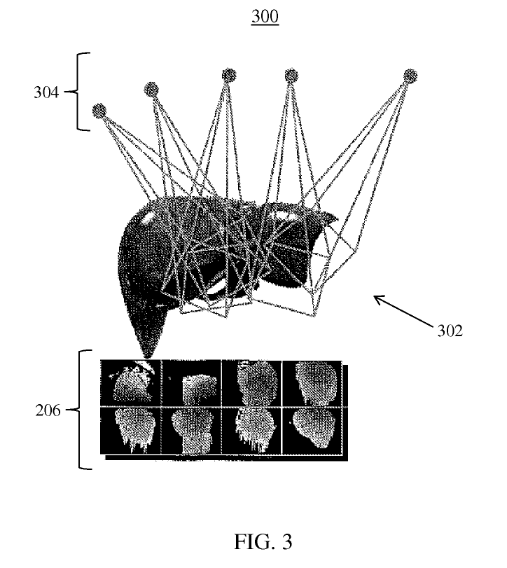

Workstation 202 generates a 3D model of anatomical object of interest 211 at the deformed state using initial intra-operative imaging data 206. FIG. 3 shows an overview for generating the 3D model, in accordance with one or more embodiments. Stitching module 224 is configured to match individually scanned frames from initial intra-operative imaging data 206 against each other in order to estimate corresponding frames based on detected image landmarks. The individually scanned frames may be acquired using image acquisition device 204 using probe 208 at positions 304 of subject 212. The pairwise computation of hypotheses for relative poses can then be determined between these corresponding frames. In one embodiment, hypotheses for relative poses between corresponding frames are estimated based on corresponding 2D image measurements and/or landmarks. In another embodiment, hypotheses for relative poses between corresponding frames are estimated based on available 3D depth channels. Other methods for computing hypotheses for relative poses between corresponding frames may also be employed.

Stitching module 224 then applies a subsequent bundle adjustment step to optimize the final sparse geometric structures in the set of estimated relative pose hypotheses, as well as the original camera poses with respect to an error metric defined in the 2D image domain by minimizing a 2D reprojection error in pixel space or in metric 3D space where a 3D distance is minimized between 3D points. After optimization, the acquired frames are represented in a single canonical coordinate system. Stitching module 224 stitches the 3D depth data of imaging data 206 into a high quality and dense intra-operative model 302 of anatomical object of interest 211 in the single canonical coordinate system. Intra-operative model 302 may be a surface mesh. For example, intra-operative model 302 may be represented as a 3D point cloud. Intra-operative model 302 includes detailed texture information of anatomical object of interest 211. Additional processing steps may be performed to create visual impressions of imaging data 206 using, e.g., known surface meshing procedures based on 3D triangulations.

Rigid registration module 226 applies a preliminarily rigid registration (or fusion) to align pre-operative model 214 and the intra-operative model generated by stitching module 224 into a common coordinate system. In one embodiment, registration is performed by identifying three or more correspondences between pre-operative module 214 and the intra-operative model. The correspondences may be identified manually based on anatomical landmarks or semi-automatically by determining unique key (salient) points, which are recognized in both the pre-operative model 214 and the 2D/3D depth maps of the intra-operative model. Other methods of registration may also be employed. For example, more sophisticated fully automated methods of registration include external tracking of probe 208 by registering the tracking system of probe 208 with the coordinate system of the pre-operative imaging data a priori (e.g., through an intra-procedural anatomical scan or a set of common fiducials).

Once pre-operative model 214 and the intra-operative model are coarsely aligned, deforming module 228 identifies dense correspondences between the vertices of pre-operative model 214 and the intra-operative model (e.g., points cloud). The dense correspondences may be identified, e.g., manually based on anatomical landmarks, semi-automatically by determining salient points, or fully automatically. Deforming module 214 then derives modes of deviations for each of the identified correspondences. The modes of deviations encode or represent spatially distributed alignment errors between pre-operative model 214 and the intra-operative model at each of the identified correspondences. The modes of deviations are converted to 3D regions of locally consistent forces, which are applied to pre-operative model 214. In one embodiment, 3D distances may be converted to a force by performing a normalization or weighting concept.

To achieve non-rigid registration, deforming module 228 defines a biomechanical model of anatomical object of interest 211 based on pre-operative model 214. The biomechanical model is defined based on mechanical parameters and pressure levels. To incorporate this biomechanical model into a registration framework, the parameters are coupled with a similarity measure, which is used to tune the model parameters. In one embodiment, the biomechanical model describes anatomical object of interest 211 as a homogeneous linear elastic solid whose motion is governed by the elastodynamics equation.

Several different methods may be used to solve this equation. For example, the total Lagrangian explicit dynamics (TLED) finite element algorithm may be used as computed on a mesh of tetrahedral elements defined in pre-operative model 214. The biomechanical model deforms mesh elements and computes the displacement of mesh points of object of interest 211 that is consistent with the regions of locally consistent forces discussed above by minimizing the elastic energy of the tissue.

The biomechanical model is combined with a similarity measure to include the biomechanical model in the registration framework. In this regard, the biomechanical model parameters are updated iteratively until model convergence (i.e., when the moving model has reached a similar geometric structure than the target model) by optimizing the similarity between the intra-operative model and the biomechanical model updated pre-operative model. As such, the biomechanical model provides a physically sound deformation of pre-operative model 214 consistent with the deformations in the intra-operative model, with the goal to minimize a pointwise distance metric between the intra-operatively gathered points and the biomechanical model updated pre-operative model 214.

While the biomechanical model of anatomical object of interest 211 is discussed with respect to the elastodynamics equation, it should be understood that other structural models (e.g., more complex models) may be employed to take into account the dynamics of the internal structures of the organ. For example, the biomechanical model of anatomical object of interest 211 may be represented as a nonlinear elasticity model, a viscous effects model, or a non-homogeneous material properties model. Other models are also contemplated.

In one embodiment, the solution to the biomechanical model may be used to provide haptic feedback to the operator of image acquisition device 204. In another embodiment, the solution to the biomechanical model may be used to guide the editing of the segmentations of imaging data 206. In other embodiments, the biomechanical model may be used for parameter identified (e.g., tissue stiffness or viscosity). For example, tissue of a patient may be actively deformed by probe 208 applying a known force and observing a displacement. An inverse problem can be solved using the biomechanical model as the solver for the forward problem of finding the optimal model parameters fitting the available data. For example, a deformation based on the biomechanical model may be based on a known deformation to update the parameters. In some embodiments, the biomechanical model may be personalized (i.e., by solving the inverse problem) before being used for non-rigid registration.

The rigid registration performed by registration module 226 aligns the recovered poses of each frame of the intra-operative model and pre-operative model 214 within a common coordinate system. Texture mapping module 230 maps the texture information of the intra-operative model to pre-operative model 214 as deformed by deforming module 228 using the common coordinate system. The deformed pre-operative model is represented as a plurality of triangulated faces. Due to high redundancy in the visual data of imaging data 206, a sophisticated labeling strategy of each visible triangulated face of the deformed pre-operative model is employed for texture mapping.

The deformed pre-operative model is represented as a labeled graph structure, where each visible triangular face of the deformed pre-operative model corresponds to a node and neighboring faces (e.g., sharing two common vertices) are connected by edges in the graph. For example, a back projection of the 3D triangles may be performed into the 2D images. Only visible triangular faces in the deformed pre-operative model are represented in the graph. The visible triangular faces may be determined based on visibility tests. For example, one visibility test determines whether all three points of the triangular face is visible. Triangular faces with less than all three points visible (e.g., only two visible points of the triangle face) may be skipped in the graph. Another exemplary visibility test considers occlusion to skip triangular faces at the backside of the pre-operative model 214 which are occluded by the front ones (e.g., using zbuffer readings using open gl). Other visibility tests may also be performed.

For each node in the graph, a set of potentials (data term) are created based on the visibility tests (e.g., the projected 2D coverage ratio) in each collected image frame. Each edge in the graph is assigned a pairwise potential, which takes into account the geometric characteristics of pre-operative model 214. Triangular faces with similar orientation are more likely to be assigned a similar label, meaning that the texture is extracted from a single frame. Images corresponding to the triangular faces are the labels. The goal is to provide large triangular faces in the images, would provide clear, high quality texture, while sufficiently reducing the number of considered images (i.e., reducing the number of label jumps) to provide smooth transitions between neighboring triangular faces. Inference can be performed by using the alpha expansion algorithm within a conditional random field formulation to determine a labeling of each triangular face. The final triangular texture can be extracted from the intra-operative model and mapped to the deformed pre-operative model based on the labeling and the common coordinate system.

Non-rigid registration module 232 then performs real-time non-rigid registration of the texture mapped, deformed pre-operative model with real-time intra-operative imaging data 207. In one embodiment, online registration of the texture mapped, deformed pre-operative model and real-time intra-operative imaging data 207 is performed following a similar approach as discussed above using the biomechanical model. In particular, the surface of the texture mapped, deformed pre-operative model is aligned with real-time intra-operative imaging data 207 by minimizing the mismatch between both the 3D depths of the intra-operative model and the texture in a first step. In a second step, a biomechanical model is solved using the textured, deformed anatomical model computed in the offline phase as initial condition, and using the new location of the model surface as boundary condition.

In another embodiment, non-rigid registration is performed by incrementally updating the texture mapped, deformed pre-operative model based on tracking certain features or landmarks on real-time intra-operative imaging data 207. For example, certain image patches may be tracked over time on real-time intra-operative imaging data 207. The tracking takes into account both the intensity features and the depth maps. In one example, the tracking may be performed using known methods. Based on the tracking information, incremental camera poses of real-time intra-operative imaging data 207 are estimated. The incremental change in position of the patches is used as the boundary condition to deform the model from the previous frame and map it to the current frame.

Advantageously, the registration of real-time intra-operative imaging data 207 and deformed pre-operative model 214 enables improved free-hand or robotic controlled navigation of probe 208. Further, workstation 202 provides for real-time, frame-by-frame updates of real-time intra-operative imaging data 207 with the deformed pre-operative model. Workstation 202 may display the deformed pre-operative model intra-operatively using display 220. In one embodiment, display 220 shows the target and critical structures overlaid on real-time intra-operative imaging data 207 in a blended mode. In another embodiment, display 220 may display the target and critical structures side-by-side.

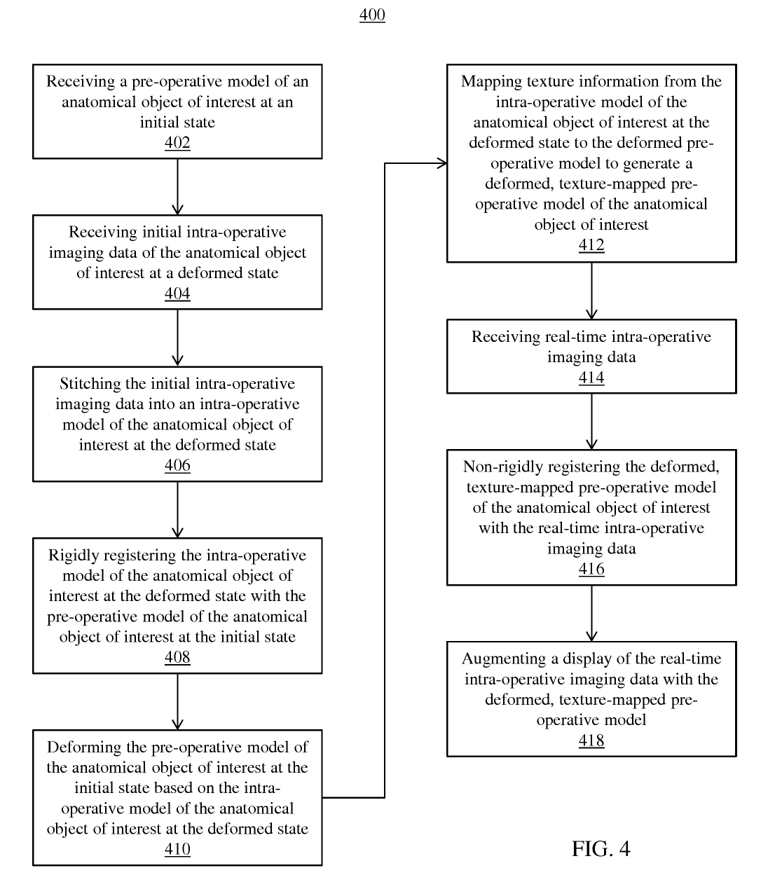

FIG. 4 shows a method 400 for guidance of laparoscopic surgical procedures at a workstation, in accordance with one or more embodiments. At step 402, a pre-operative model of an anatomical object of interest at an initial (e.g., relaxed or non-deformed) state is received. The pre-operative model may be generated from an image acquisition device of any modality. For example, the pre-operative model may be generated from pre-operative imaging data from a CT or MRI.

At step 404, initial intra-operative imaging data of the anatomical object of interest at a deformed state is received. The initial intra-operative imaging data may be acquired at an initial stage of the procedure to provide a complete scanning of the anatomical object of interest. The initial intra-operative imaging data may be generated from an image acquisition device of any modality. For example, the initial intra-operative imaging data may be from a stereoscopic laparoscopic imaging device capable of producing real-time 2D and 3D depth maps. The anatomical object of interest at the deformed state may be deformed due insufflation of the abdomen or any other factor, such as, e.g., the natural internal motion of the patient, displacement from an imaging or surgical device, etc.

At step 406, the initial intra-operative imaging data is stitched into an intra-operative model of the anatomical object of interest at the deformed state. Individually scanned frames of the initial intra-operative imaging data are matched with each other to identify corresponding fames based on detected imaging landmarks. A set of hypotheses for relative poses between corresponding frames is determined. The hypotheses may be estimated based on corresponding image measurements and landmarks, or based on available 3D depth channels. The set of hypotheses are optimized to generate an intra-operative model of the anatomical object of interest at the deformed state.

At step 408, the intra-operative model of the anatomical object of interest at the deformed state is rigidly registered with the pre-operative model of the anatomical object of interest at the initial state. The rigid registration may be performed by identifying three or more correspondences between the intra-operative model and the pre-operative model. The correspondences may be identified manually, semi-automatically, or fully-automatically.

At step 410, the pre-operative model of the anatomical object of interest at the initial state is deformed based on the intra-operative model of the anatomical object of interest at the deformed state. In one embodiment, dense correspondences are identified between the pre-operative model and the intra-operative model. Modes of deviations representing misalignments between the pre-operative model and the intra-operative model are determined. The misalignments are converted to regions of locally consistent forces, which are applied to the pre-operative model to perform the deforming.

In one embodiment, a biomechanical model of the anatomical object of interest is defined based on the pre-operative model. The biomechanical model computes the shape of the anatomical object of interest consistent with the regions of locally consistent forces. The biomechanical model is combined with an intensity similarity measure to perform non-rigid registration. The biomechanical model parameters are iteratively updated until convergence to minimize a distance metric between the intra-operative model and the biomechanical model updated pre-operative model.

At step 412, texture information is mapped from the intra-operative model of the anatomical object of interest at the deformed state to the deformed pre-operative model to generate a deformed, texture-mapped pre-operative model of the anatomical object of interest. The mapping may be performed by representing the deformed pre-operative as a graph structure. Triangular faces visible on the deformed pre-operative model correspond to nodes of the graph and neighboring faces (e.g., sharing two common vertices) are connected by edges. The nodes are labeled and the texture information is mapped based on the labeling.

At step 414, real-time intra-operative imaging data is received. The real-time intra-operative imaging data may be acquired during the procedure.

At step 416, the deformed, texture-mapped pre-operative model of the anatomical object of interest is non-rigidly registered with the real-time intra-operative imaging data. In one embodiment, non-rigid registration may be performed by first aligning the deformed, texture-mapped pre-operative model with the real-time intra-operative imaging data by minimizing a mismatch in both 3D depth and texture. In a second step, the biomechanical model is solved using the textured, deformed pre-operative model as the initial condition and the new location of the model surface as a boundary condition. In another embodiment, non-rigid registration may be performed by tracking a position of features of the real-time intra-operative imaging data over time and further deforming the deformed, texture-mapped pre-operative model based on the tracked position of the features.

At step 418, a display of the real-time intra-operative imaging data is augmented with the deformed, texture-mapped pre-operative model. For example, the deformed, texture-mapped pre-operative model may be displayed overlaid on the real-time intra-operative imaging data or in a side-by-side configuration.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 4. Certain steps of the methods described herein, including one or more of the steps of FIG. 4, may be performed by a server or by another processor in a network-based cloud-computing system. Certain steps of the methods described herein, including one or more of the steps of FIG. 4, may be performed by a client computer in a network-based cloud computing system. The steps of the methods described herein, including one or more of the steps of FIG. 4, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

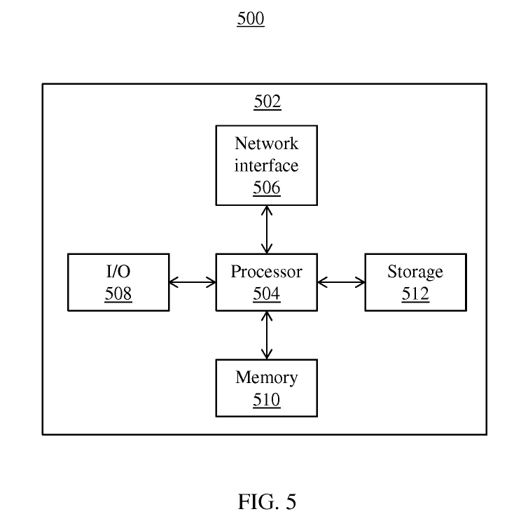

A high-level block diagram 500 of an example computer that may be used to implement systems, apparatus, and methods described herein is depicted in FIG. 5. Computer 502 includes a processor 504 operatively coupled to a data storage device 512 and a memory 510. Processor 504 controls the overall operation of computer 502 by executing computer program instructions that define such operations. The computer program instructions may be stored in data storage device 512, or other computer readable medium, and loaded into memory 510 when execution of the computer program instructions is desired. Thus, the method steps of FIG. 4 can be defined by the computer program instructions stored in memory 510 and/or data storage device 512 and controlled by processor 504 executing the computer program instructions. For example, the computer program instructions can be implemented as computer executable code programmed by one skilled in the art to perform the method steps of FIG. 4 and workstations 102 and 202 of FIGS. 1 and 2 respectively. Accordingly, by executing the computer program instructions, the processor 504 executes the method steps of FIG. 4 and workstations 102 and 202 of FIGS. 1 and 2 respectively. Computer 502 may also include one or more network interfaces 506 for communicating with other devices via a network. Computer 502 may also include one or more input/output devices 508 that enable user interaction with computer 502 (e.g., display, keyboard, mouse, speakers, buttons, etc.).

Processor 504 may include both general and special purpose microprocessors, and may be the sole processor or one of multiple processors of computer 502. Processor 504 may include one or more central processing units (CPUs), for example. Processor 504, data storage device 512, and/or memory 510 may include, be supplemented by, or incorporated in, one or more application-specific integrated circuits (ASICs) and/or one or more field programmable gate arrays (FPGAs).

Data storage device 512 and memory 510 each include a tangible non-transitory computer readable storage medium. Data storage device 512, and memory 510, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 508 may include peripherals, such as a printer, scanner, display screen, etc. For example, input/output devices 508 may include a display device such as a cathode ray tube (CRT) or liquid crystal display (LCD) monitor for displaying information to the user, a keyboard, and a pointing device such as a mouse or a trackball by which the user can provide input to computer 502.

Any or all of the systems and apparatus discussed herein, including elements of workstations 102 and 202 of FIGS. 1 and 2 respectively, may be implemented using one or more computers such as computer 502.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for model augmentation, comprising:
receiving intra-operative imaging data of an anatomical object of interest at a deformed state;
stitching the intra-operative imaging data into an intra-operative model of the anatomical object of interest at the deformed state;
registering the intra-operative model of the anatomical object of interest at the deformed state with a pre-operative model of the anatomical object of interest at an initial state by deforming the pre-operative model of the anatomical object of interest at the initial state based on a biomechanical model; and
mapping texture information from the intra-operative model of the anatomical object of interest at the deformed state to the deformed pre-operative model to generate a deformed, texture-mapped pre-operative model of the anatomical object of interest.

2. The method as recited in claim 1, wherein stitching the intra-operative imaging data into an intra-operative model of the anatomical object of interest at the deformed state further comprises:
identifying corresponding frames in the intra-operative imaging data;
computing hypotheses for relative poses between the corresponding frames; and
generating the intra-operative model based on the hypotheses.

3. The method as recited in claim 2, wherein computing hypotheses for relative poses between the corresponding frames is based on at least one of:
corresponding image measurements and landmarks; and
three-dimensional depth channels.

4. The method as recited in claim 1, wherein registering the intra-operative model of the anatomical object of interest at the deformed state with a pre-operative model of the anatomical object of interest at an initial state further comprises:
rigidly registering the intra-operative model of the anatomical object of interest at the deformed state with the pre-operative model of the anatomical object of interest at the initial state by identifying at least three correspondences between the intra-operative model of the anatomical object of interest at the deformed state and pre-operative model of the anatomical object of interest at the initial state.

5. The method as recited in claim 1, wherein deforming the pre-operative model of the anatomical object of interest at the initial state based on a biomechanical model further comprises:
identifying dense correspondences between the pre-operative model of the anatomical object of interest at the initial state and the intra-operative model of the anatomical object of interest at the deformed state;
determining misalignments between the pre-operative model of the anatomical object of interest at the initial state and the intra-operative model of the anatomical object of interest at the deformed state at the identified dense correspondences;
converting the misalignments to regions of consistent forces; and
applying the regions of consistent forces to the pre-operative model of the anatomical object of interest at the initial state.

6. The method as recited in claim 5, wherein deforming the pre-operative model of the anatomical object of interest at the initial state based on a biomechanical model further comprises:
deforming the pre-operative model of the anatomical object of interest based on the regions of consistent forces in accordance with the biomechanical model of the anatomical object of interest; and
minimizing a distance metric between the deformed pre-operative model and the intra-operative model.

7. The method as recited in claim 1, wherein mapping texture information from the intra-operative model of the anatomical object of interest at the deformed state to the deformed pre-operative model to generate a deformed, texture-mapped pre-operative model of the anatomical object of interest further comprises:
representing the deformed, texture-mapped pre-operative model of the anatomical object of interest as a graph having triangular faces visible on the intra-operative model corresponding to nodes of the graph and neighboring faces connected by edges in the graph;
labeling nodes based on one or more visibility tests; and
mapping the texture information based on the labeling.

8. The method as recited in claim 1, further comprising:
non-rigidly registering the deformed, texture-mapped pre-operative model of the anatomical object of interest with real-time intra-operative imaging data of the anatomical object of interest.

9. The method as recited in claim 8, wherein non-rigidly registering the deformed, texture-mapped pre-operative model of the anatomical object of interest with real-time intra-operative imaging data of the anatomical object of interest further comprises:
aligning the deformed, texture-mapped pre-operative model and the real-time intra-operative imaging data by minimizing a mismatch in depth and texture; and
solving the biomechanical model of the anatomical object of interest using the deformed, texture-mapped pre-operative model as an initial condition and a new location of a surface of the deformed, texture-mapped pre-operative model as a boundary condition.

10. The method as recited in claim 8, wherein non-rigidly registering the deformed, texture-mapped pre-operative model of the anatomical object of interest with real-time intra-operative imaging data of the anatomical object of interest further comprises:
tracking a position of features of the real-time intra-operative imaging data over time; and
deforming the deformed, texture-mapped pre-operative model based on the tracked position of the features.

11. The method as recited in claim 8, further comprising:
augmenting a display of the real-time intra-operative imaging data with the deformed, texture-mapped pre-operative model.

12. The method as recited in claim 11, wherein augmenting a display of the real-time intra-operative imaging data with the deformed, texture-mapped pre-operative model comprises at least one of:
displaying the deformed, texture-mapped pre-operative model overlaid on the real-time intra-operative imaging data; and
displaying the deformed, texture-mapped pre-operative model and the real-time intra-operative imaging data side-by-side.

13. An apparatus for model augmentation, comprising:
means for receiving intra-operative imaging data of an anatomical object of interest at a deformed state;
means for stitching the intra-operative imaging data into an intra-operative model of the anatomical object of interest at the deformed state;
means for registering the intra-operative model of the anatomical object of interest at the deformed state with a pre-operative model of the anatomical object of interest at an initial state by deforming the pre-operative model of the anatomical object of interest at the initial state based on a biomechanical model; and
means for mapping texture information from the intra-operative model of the anatomical object of interest at the deformed state to the deformed pre-operative model to generate a deformed, texture-mapped pre-operative model of the anatomical object of interest.

14.-16. (canceled)

17. The apparatus as recited in claim 13, wherein the means for deforming the pre-operative model of the anatomical object of interest at the initial state based on a biomechanical model further comprises:
means for identifying dense correspondences between the pre-operative model of the anatomical object of interest at the initial state and the intra-operative model of the anatomical object of interest at the deformed state;
means for determining misalignments between the pre-operative model of the anatomical object of interest at the initial state and the intra-operative model of the anatomical object of interest at the deformed state at the identified dense correspondences;
means for converting the misalignments to regions of consistent forces; and
means for applying the regions of consistent forces to the pre-operative model of the anatomical object of interest at the initial state.

18. The apparatus as recited in claim 17, wherein the means for deforming the pre-operative model of the anatomical object of interest at the initial state based on a biomechanical model further comprises:
means for deforming the pre-operative model of the anatomical object of interest based on the regions of consistent forces in accordance with the biomechanical model of the anatomical object of interest; and
means for minimizing a distance metric between the deformed pre-operative model and the intra-operative model.

19. The apparatus as recited in claim 13, wherein the means for mapping texture information from the intra-operative model of the anatomical object of interest at the deformed state to the deformed pre-operative model to generate a deformed, texture-mapped pre-operative model of the anatomical object of interest further comprises:
means for representing the deformed, texture-mapped pre-operative model of the anatomical object of interest as a graph having triangular faces visible on the intra-operative model corresponding to nodes of the graph and neighboring faces connected by edges in the graph;
means for labeling nodes based on one or more visibility tests; and
means for mapping the texture information based on the labeling.

20.-24. (canceled)

25. A non-transitory computer readable medium storing computer program instructions for model augmentation, the computer program instructions when executed by a processor cause the processor to perform operations comprising:
receiving intra-operative imaging data of an anatomical object of interest at a deformed state;
stitching the intra-operative imaging data into an intra-operative model of the anatomical object of interest at the deformed state;
registering the intra-operative model of the anatomical object of interest at the deformed state with a pre-operative model of the anatomical object of interest at an initial state by deforming the pre-operative model of the anatomical object of interest at the initial state based on a biomechanical model; and
mapping texture information from the intra-operative model of the anatomical object of interest at the deformed state to the deformed pre-operative model to generate a deformed, texture-mapped pre-operative model of the anatomical object of interest.

26.-27. (canceled)

28. The non-transitory computer readable medium as recited in claim 25, wherein deforming the pre-operative model of the anatomical object of interest at the initial state based on a biomechanical model further comprises:
identifying dense correspondences between the pre-operative model of the anatomical object of interest at the initial state and the intra-operative model of the anatomical object of interest at the deformed state;
determining misalignments between the pre-operative model of the anatomical object of interest at the initial state and the intra-operative model of the anatomical object of interest at the deformed state at the identified dense correspondences;
converting the misalignments to regions of consistent forces; and
applying the regions of consistent forces to the pre-operative model of the anatomical object of interest at the initial state.

29. The non-transitory computer readable medium as recited in claim 28, wherein deforming the pre-operative model of the anatomical object of interest at the initial state based on a biomechanical model further comprises:
deforming the pre-operative model of the anatomical object of interest based on the regions of consistent forces in accordance with the biomechanical model of the anatomical object of interest; and
minimizing a distance metric between the deformed pre-operative model and the intra-operative model.

30. The non-transitory computer readable medium as recited in claim 25, wherein mapping texture information from the intra-operative model of the anatomical object of interest at the deformed state to the deformed pre-operative model to generate a deformed, texture-mapped pre-operative model of the anatomical object of interest further comprises:
representing the deformed, texture-mapped pre-operative model of the anatomical object of interest as a graph having triangular faces visible on the intra-operative model corresponding to nodes of the graph and neighboring faces connected by edges in the graph;
labeling nodes based on one or more visibility tests; and
mapping the texture information based on the labeling.

31.-34. (canceled)
